(19) United States
(12) Patent Application Publication
(10) Pub. No.: US 2019/0143544 A1
(43) Pub. Date: May 16, 2019

(54) FOLDING KNIFE WITH ROTATABLE FINGER TAB

(71) Applicant: Kai U.S.A., Ltd., Tualatin, OR (US)

(72) Inventors: Gustavo Thome Cecchini, Sao Jose do Rio Preto (BR); James MacNair, Newberg, OR (US); Timothy James Galyean, Newberg, OR (US)

(73) Assignee: KAI U.S.A., Ltd., Tualatin, OR (US)

(21) Appl. No.: 15/812,983

(22) Filed: Nov. 14, 2017

(51) Int. Cl. B26B 1/04

(52) U.S. Cl. CPC B26B 1/042

(57) ABSTRACT

A folding knife includes a handle and a blade rotatably connected to the handle, the blade rotatable between a closed position and an opened position about a blade axis. A finger tab is useable to rotate the blade from the closed position to the opened position, the finger tab rotatably connected to the blade and rotatable between a retracted position and an extended position about a tab axis parallel to the blade axis. A torsion spring biases the finger tab toward the retracted position.

### SUMMARY

A knife includes a handle and a blade rotatably connected to the handle, the blade rotatable between a closed position and an opened position about a blade axis. A finger tab is useable to rotate the blade from the closed position to the opened position, the finger tab rotatably connected to the blade and rotatable between a retracted position and an extended position about a tab axis parallel to the blade axis. A torsion spring biases the finger tab toward the retracted position.

### BRIEF DESCRIPTION OF THE DRAWINGS

FIGS. 1A, 1B, and 1C illustrate opening of an example knife in accordance with an embodiment of the present disclosure.

FIGS. 2A, 2B, and 2C are section views of the knife of FIGS. 1A, 1B, and 1C, illustrating rotation of a finger tab.

FIGS. 3A and 3B illustrate finger tab position when the knife of FIGS. 1A, 1B, and 1C is in closed and opened positions.

FIG. 4 is an exploded view of some components of the knife of FIGS. 1A, 1B, and 1C.

### DETAILED DESCRIPTION

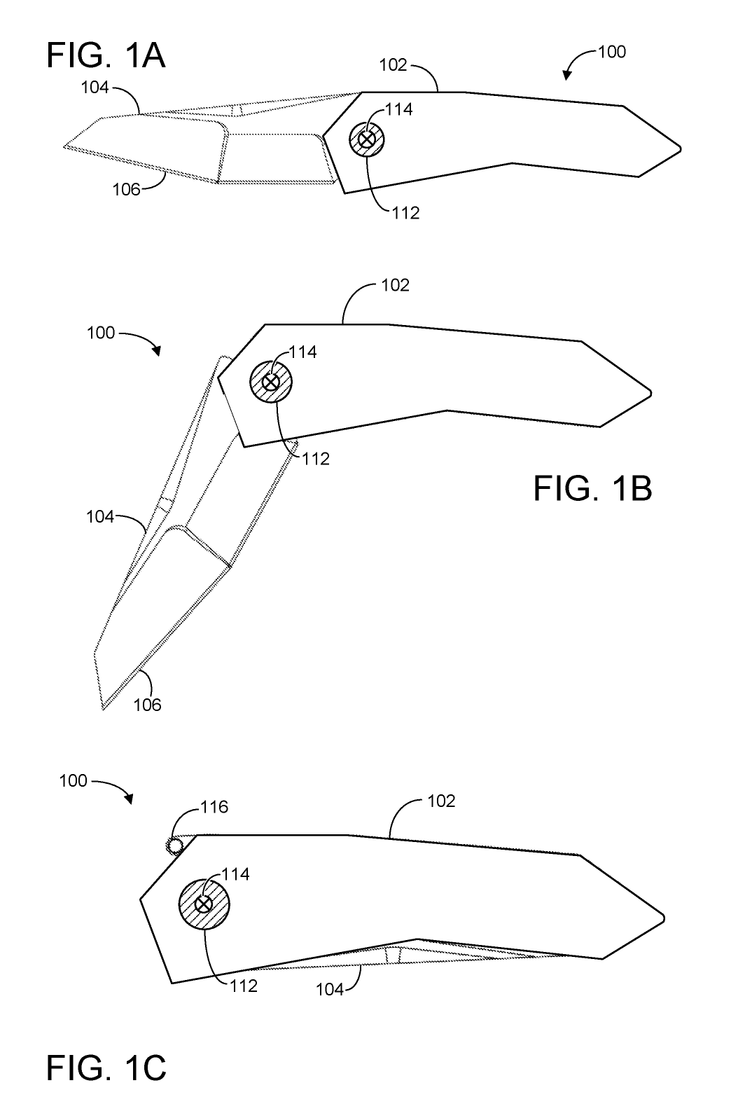

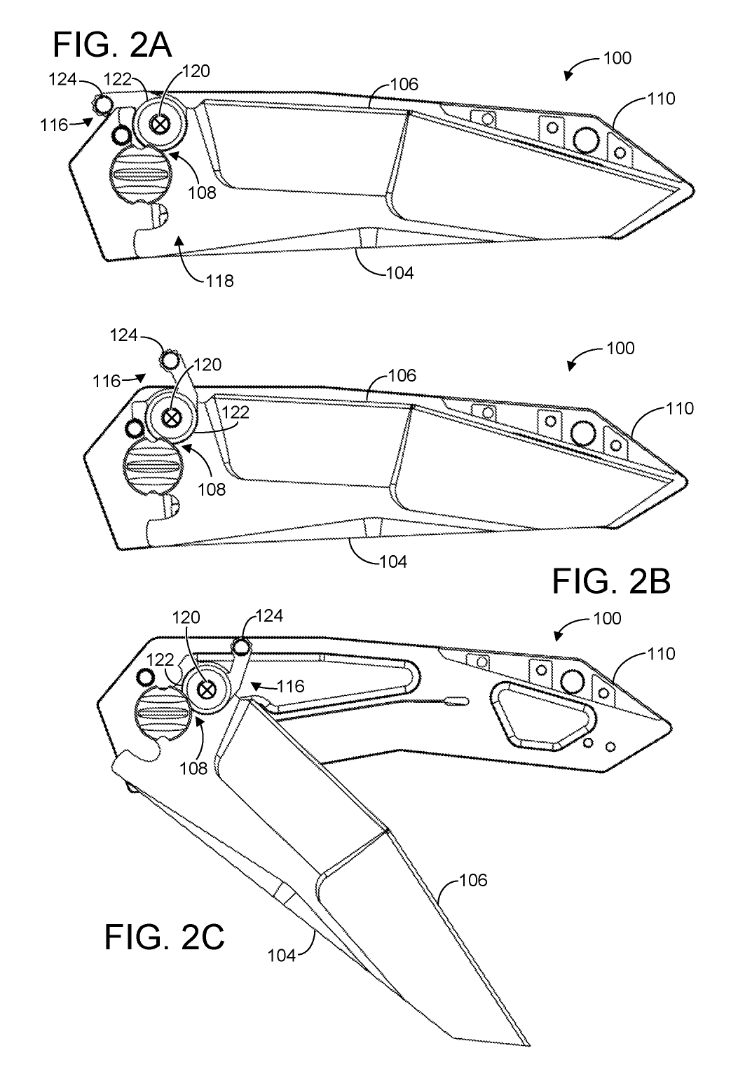

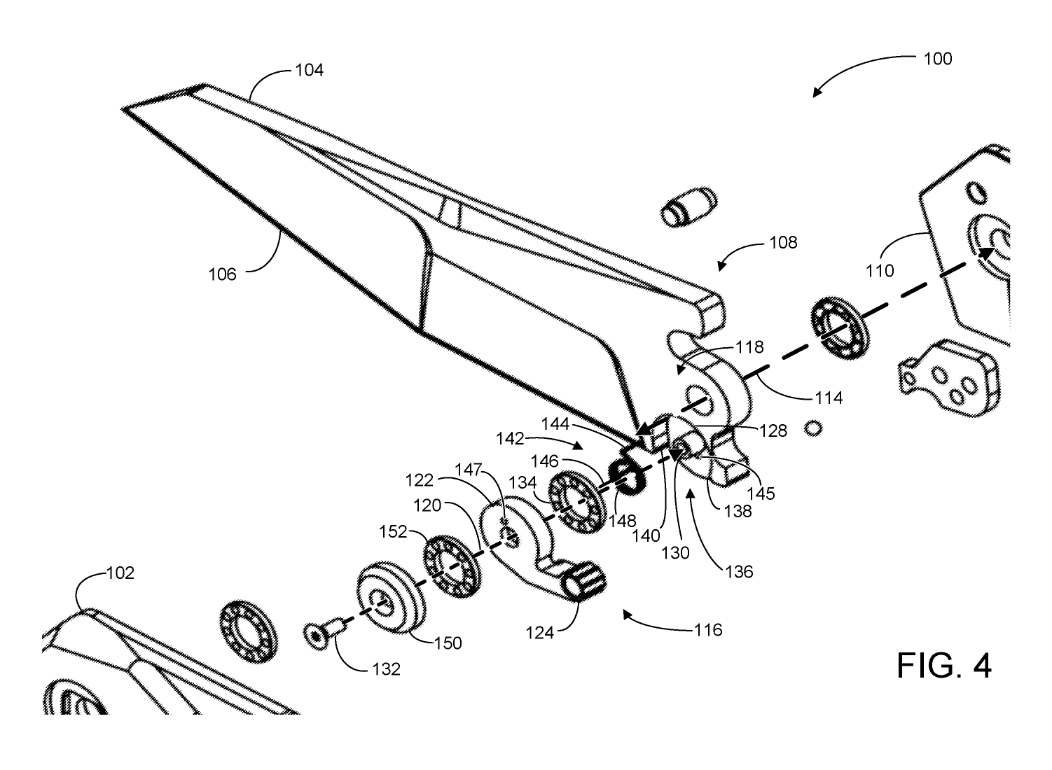

FIG. 1A shows a side view of an example knife 100 in accordance with an example embodiment of the present disclosure. Knife 100 includes a handle 102 and a blade 104 rotatably connected to the handle, the blade 104 having a cutting edge 106. Blade 104 also has a tang 108, described below with respect to FIGS. 2 and 4. In some cases, knife 100 may include two separate handle portions, with the blade disposed between the two handle portions and rotatably connected to each handle portion. Accordingly, knife 100 also includes a second handle portion 110, described below with respect to FIGS. 2 and 4. Second handle portion 110 will be referred to herein as the “back handle” of knife 100, while handle 102 will be referred to as the “front handle.” Back handle 110 is occluded in FIG. 1A by front handle 102. The word “handle” on its own will be used to refer to either the front or the back handle individually, or both the front and back handles collectively.

Blade 104 is rotatably connected to front handle 102 via pivot 112. This connection allows blade 104 to rotate between an opened position and a closed position about a blade axis 114, shown as a cross within a circle to indicate that the blade axis goes into the page. In FIG. 1A, knife 100 is shown with blade 104 in an opened position relative to the handle. FIG. 1B shows blade 104 of knife 100 in a partially opened position, in which blade 104 has been rotated such that cutting edge 106 has moved toward the handle. Finally, FIG. 1C shows blade 104 in a closed position, in which the blade has been rotated such that cutting edge 106 is now recessed within the handle, allowing knife 100 to be safely carried or stored.

Also shown in FIG. 1C is a finger tab 116, useable to rotate the blade from the closed position to the opened position. In other words, finger tab 116 may be manipulated by a human user of knife 100 to safely and conveniently move blade 104 from the closed position to the opened position.

Finger tab 116 will now be described in more detail with respect to FIGS. 2A, 2B, and 2C, which show knife 100 without front handle 102, thereby exposing back handle 110. Specifically, FIG. 2A shows knife 100 with blade 104 in the closed position. As shown, tang 108 of blade 104 has a broad side 118, and finger tab 116 is connected to the broad side of the tang.

In some cases, the finger tab is rotatably connected to the blade, such that the finger tab is rotatable between a retracted position and an extended position about a tab axis 120 parallel to the blade axis. Similar to blade axis 114, tab axis 120 is shown as a cross within a circle to indicate that the tab axis goes into the page. As shown, finger tab 116 includes a ring portion 122 and a gripping portion 124, with tab axis 120 running through the center of the ring portion of the finger tab. In FIG. 2A, finger tab 116 is shown in the retracted position. In some cases, the finger tab may be biased toward the retracted position by a torsion spring, as will be described in more detail below. Sufficient application of force to the gripping portion of finger tab 116 can cause rotation of the finger tab about tab axis 120 from the retracted position to the extended position, depicted in FIG. 2B. Once the finger tab is in the extended position, continued application of force to the finger tab is transferred to blade 104. Should sufficient force be applied, movement of the blade from the closed position to the opened position can be initiated, allowing the blade to be safely opened through manipulation of the finger tab. This is illustrated in FIG. 2C, in which force applied to finger tab 116 has caused blade 104 to move from the closed position to a partially-opened position.

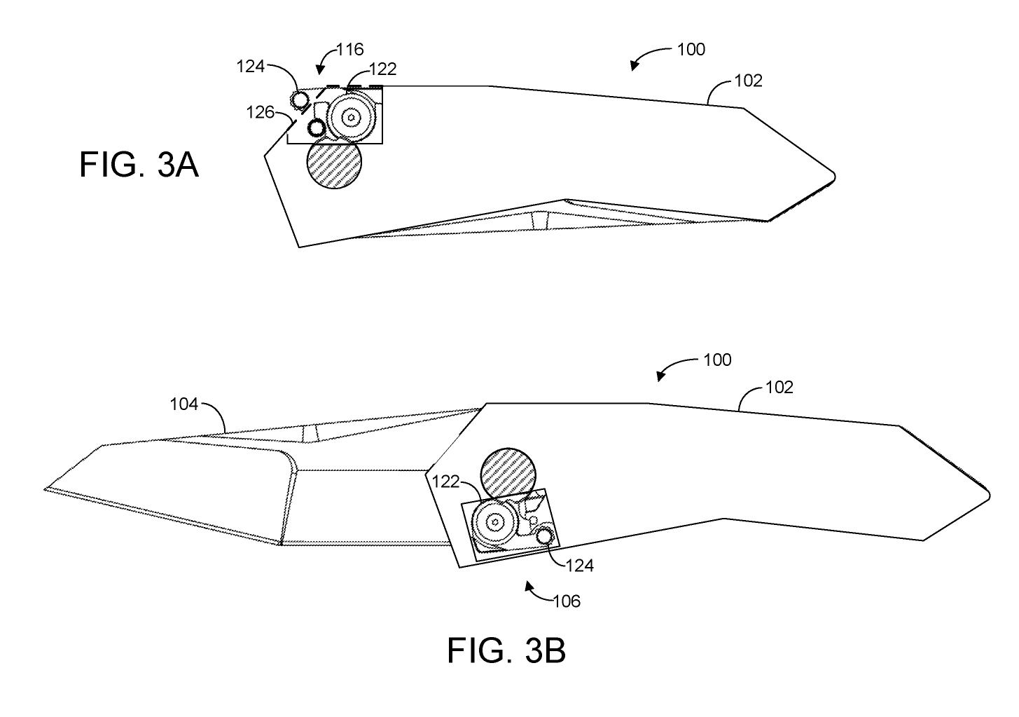

FIG. 3A shows another view of knife 100 while blade 104 is in the closed position. As shown, a small window of front handle 102 has been cut away to reveal portions of finger tab 116 that otherwise would be occluded by the front handle. Ring portion 122 is recessed within the handle of knife 100, while the gripping portion of finger tab 116 extends beyond an edge 126 of handle 102, indicated in FIG. 3A by a dashed line. Because the gripping portion of the finger tab extends beyond the edge of the handle, the gripping portion is positioned for easy access by a human attempting to move blade 104 from the closed position to the opened position.

FIG. 3B shows a different view of knife 100 while blade 104 is in the opened position. In FIG. 3B, a different portion of handle 102 has been cut away to reveal the position of finger tab 116 while the blade is in the opened position. As shown, both the ring and gripping portions of finger tab 116 are now recessed within the handle of knife 100. In other words, while the blade is in the closed position, the gripping portion of the finger tab extends beyond the edge of the handle. As the blade moves to the opened position, the position of the finger tab relative to the handle changes, such that the gripping portion of the finger tab is recessed within the handle when the blade is in the opened position. In this manner, the gripping portion of the finger tab is positioned for easy access by a human when the blade is in the closed position, allowing the human to easily open the blade. Once the blade is opened and the finger tab is no longer needed, the gripping portion of the finger tab is stowed within the handle, thus creating a cleaner profile that is less likely to snag on clothing or interfere with gripping the handle.

Individual structures and components of folding knife 100 will now be described with more detail with respect to FIG. 4, which shows an exploded view of components of folding knife 100, with a general focus on components that relate to the finger tab. It will be understood that not all components of folding knife 100 are shown in FIG. 4. Further, the specific components shown in FIG. 4 are presented as non-limiting examples. Alternative implementations may include additional components not shown in FIG. 4, and/or need not include all components in FIG. 4. Further, it will be understood that the specific shapes, sizes, positions, and/or structural relationships of components shown in FIG. 4 can vary from implementation to implementation.

In FIG. 4, blade 104 of folding knife 100 defines a circular indentation 128 around a threaded hole 130. As discussed above, finger tab 116 includes a ring portion 122 and a gripping portion 124. As shown in FIG. 4, in some cases, gripping portion 124 may be thicker than the ring portion 122 in a dimension parallel to tab axis 120. In FIG. 4, tab axis 120 is shown as a dashed arrow. When assembled, finger tab 116 is secured to blade 104 by a screw 132 threaded into threaded hole 130. In some examples, screw 132 may extend along finger tab axis 120. Folding knife 100 may additionally include a ring of bearings 134 positioned between the finger tab and blade 104, which may serve to facilitate rotation of finger tab about finger tab axis 120. It will be understood that circular indentation 128 need not be exactly circular, but rather may assume any shape that allows rotation of the ring portion 122. Further, in some implementations threaded hole 130 need not be threaded. In such cases, finger tab 116 may be secured to blade 104 via any suitable fastener, such as a rivet, as a non-limiting example.

In some cases, circular indentation 128 may be sized and shaped such that the ring portion 122 of finger tab 116 fits into the circular indentation. In other words, when attached to blade 104, the ring portion of the finger tab may fit within the circular indentation defined by blade 104, such that the gripping portion of the finger tab extends through a mouth 136 of the circular indentation for access by a human. In FIG. 4, circular indentation 128 defines an arced sidewall having a back end 138 and a front end 140. Back end 138 and front end 140 of the arced sidewall may serve to limit rotation of the finger tab about the tab axis, such that the back end of the arced sidewall constrains the finger tab from rotating past the retracted position and the front end of the arced sidewall constrains the finger tab from rotating past the extended position.

As indicated above, in some examples the finger tab may be biased toward the retracted position. In other words, the retracted position may be considered as the default or resting position of the finger tab, such that the finger tab occupies the retracted position when no force is applied to the finger tab. Only when sufficient force is applied to the finger tab to overcome a biasing force does the finger tab move to the extended position.

In some cases, this biasing force may be supplied by a torsion spring, such as torsion spring 142. In the example of FIG. 4, torsion spring 142 is a helical torsion spring, and extends perpendicularly out of broad side 118 of the tang 108 of blade 104. However, it will be understood that any suitable variety of torsion spring may be used in addition to or in lieu of helical torsion spring 142.

In the illustrated example, helical torsion spring 142 has a first end 144 extending substantially parallel to tab axis 120 in the direction of the blade, such that when knife 100 is assembled, first end 144 extends into hole 145 within the circular indentation 128 of the blade. Similarly, helical torsion spring 142 has a second end 146 extending substantially parallel to the tab axis that, when assembled, extends into hole 147 of the finger tab 116. In this manner, helical torsion spring 142 may provide a torsional biasing force that resists rotation of the finger tab 116 relative to the blade 104. Should sufficient force be applied to the finger tab to overcome the biasing force (e.g., by a human user of knife 100), the finger tab can be moved to the extended position. Contact between the finger tab and front end of the arced sidewall causes force applied to the finger tab to be similarly applied to the blade, which may cause the blade to open.

Helical torsion spring 142 additionally includes a shaft 148 that fits within circular indentation 128 and around threaded hole 130. In some examples, tab axis 120 may extend through the shaft of the helical torsion spring. In some examples, the shaft of the helical torsion spring and the tab axis may be concentric, such that they share a common geometric center. In other examples, however, the tab axis may be offset from the center of the torsion spring.

In some cases, the finger tab may be additionally secured to blade 104 via a bearing cap 150, such that screw 132 extends through the bearing cap and into threaded hole 130 of blade 104 to secure the finger tab between the bearing cap and the blade. Knife 100 may additionally include a ring of bearings 152 disposed between the finger tab 116 and bearing cap 150, which may further serve to facilitate rotation of the finger tab about tab axis 120.

It will be understood that the configurations and/or approaches described herein are exemplary in nature, and that these specific implementations or examples are not to be considered in a limiting sense, because numerous variations are possible.

The subject matter of the present disclosure includes all novel and nonobvious combinations and subcombinations of the various objects, structures, mechanisms, and other features, functions, acts, and/or properties disclosed herein, as well as any and all equivalents thereof.

1. A knife, comprising:
a handle;
a blade rotatably connected to the handle, the blade rotatable between a closed position and an opened position about a blade axis;
a finger tab useable to rotate the blade from the closed position to the opened position, the finger tab rotatably connected to the blade, the finger tab rotatable between a retracted position and an extended position about a tab axis parallel to the blade axis; and
a torsion spring biasing the finger tab toward the retracted position.

2. The knife of claim 1, wherein the torsion spring is a helical torsion spring.

3. The knife of claim 2, wherein the helical torsion spring has a first end extending substantially parallel to the tab axis into the blade and a second end extending substantially parallel to the tab axis into the finger tab.

4. The knife of claim 2, wherein the tab axis extends through a shaft of the helical torsion spring.

5. The knife of claim 4, wherein the tab axis and the helical torsion spring are concentric.

6. The knife of claim 1, wherein the blade includes a tang having a broad side, and wherein the torsion spring extends perpendicularly out of the broad side of the tang.

7. The knife of claim 1, wherein the finger tab includes a ring portion and a gripping portion extending from the ring portion.

8. The knife of claim 7, wherein the gripping portion is thicker than the ring portion in a dimension parallel to the tab axis.

9. The knife of claim 7, wherein the blade defines a circular indentation into which the ring portion of the finger tab fits.

10. The knife of claim 9, wherein the gripping portion of the finger tab extends through a mouth of the circular indentation.

11. The knife of claim 9, wherein the circular indentation has an arced sidewall having a front end and a back end, wherein the back end of the arced sidewall constrains the finger tab from rotating past the retracted position and the front end of the arced sidewall constrains the finger tab from rotating past the extended position.

12. The knife of claim 1, wherein the blade defines a circular indentation around a threaded hole.

13. The knife of claim 12, wherein the finger tab is secured to the blade by a screw threaded into the threaded hole.

14. The knife of claim 1, further comprising a ring of bearings between the finger tab and the blade.

15. The knife of claim 1, further comprising a bearing cap and a screw, wherein the screw extends through the bearing cap into a threaded hole of the blade to secure the finger tab between the bearing cap and the blade.

16. The knife of claim 15, further comprising a ring of bearings between the finger tab and the bearing cap.

17. The knife of claim 15, wherein the screw extends along the finger tab axis.

18. The knife of claim 1, wherein the gripping portion of the finger tab extends beyond an edge of the handle when the blade is in the closed position, and wherein the gripping portion of the finger tab is recessed within the handle when the blade is in the opened position.

19. A knife, comprising:
a handle;
a blade rotatably connected to the handle, the blade rotatable between a closed position and an opened position;
a finger tab useable to rotate the blade from the closed position to the opened position, the finger tab rotatably connected to a broad side of the blade, the finger tab rotatable between a retracted position and an extended position; and
a helical torsion spring perpendicularly extending out of the broad side of the blade into a broad side of the finger tab and biasing the finger tab toward the retracted position.

20. A knife, comprising:
a handle;
a blade rotatably connected to the handle, the blade rotatable between a closed position and an opened position;
a finger tab useable to rotate the blade from the closed position to the opened position, the finger tab rotatably connected to the blade, the finger tab rotatable between a retracted position and an extended position; and
a helical torsion spring biasing the finger tab toward the retracted position, wherein a gripping portion of the finger tab extends beyond an edge of the handle when the blade is in the closed position, and wherein the gripping portion of the finger tab is recessed within the handle when the blade is in the opened position.
